(19) United States
(12) Patent Application Publication
(10) Pub. No.: US 2008/0196403 A1
(43) Pub. Date: Aug. 21, 2008

(54) Master Cylinder

(76) Inventor: Eric Anderson, Plover, WI (US)

Correspondence Address: MCDONALD HOPKINS LLC, 600 Superior Avenue, East, Suite 2100, CLEVELAND, OH, 44114-2653, US

(21) Appl. No.: 11/982,722

(22) Filed: Nov. 2, 2007

Related U.S. Application Data
(60) Provisional application No. 60/856,228, filed on Nov. 2, 2006.

(51) Int. Cl. B60T 11/28

(52) U.S. Cl. 60/589

(57) ABSTRACT

The present invention is directed to apparatus, systems, and methods for incorporating a master cylinder into a hydraulic brake system. An embodiment of the present invention includes a housing, a bore extending through the housing, a cover, and a groove formed in the cover. The housing includes a fluid reservoir formed therein. The bore is capable of supporting a movable piston to actuate the hydraulic braking system. The cover is secured to the housing and the groove in the cover descends away from the center of the cover such that the groove is capable of directing fluid away from the center of the cover.

### CROSS-REFERENCE TO RELATED APPLICATIONS

The application claims priority from U.S. Provisional Patent Application No. 60/856,228, entitled “MASTER CYLINDER” and filed on Nov. 2, 2006, which is hereby incorporated by reference in its entirety.

### FIELD OF THE INVENTION

The present invention is generally related to hydraulic brake system components, and more particularly, to master cylinders.

### BACKGROUND

Master cylinders are often designed for use with hydraulic braking systems for vehicles. Master cylinders are commonly incorporated into braking assemblies in a variety of vehicles such as, for example, towing trailers, motorcycles, and the like. In the trailer industry, master cylinders are incorporated into surge brake actuators for towing trailers to actuate the trailer's braking system when the towing vehicle pulling the trailer is braking or otherwise slowing. For example, when a vehicle towing a trailer slows or stops, the trailer surges forward with respect to the towing vehicle. A master cylinder mounted onto the trailer may sense the surging of the trailer and actuate the trailer's braking system to apply a braking force to the wheels of the trailer, thus slowing or stopping the trailer in coordination with the slowing or stopping of the towing vehicle.

Master cylinders are important to the trailer industry because master cylinders facilitate the safe and effective operation of trailers being pulled by towing vehicles. Therefore, it is continuously desirable to develop novel apparatus, systems, and methods that improve upon master cylinders used in the trailer industry.

### SUMMARY

The present invention is directed to apparatus, systems, and methods for incorporating a master cylinder into a hydraulic brake system. An embodiment of the present invention includes a housing, a bore extending through the housing, a cover, and a groove formed in the cover. The housing includes a fluid reservoir formed therein. The bore is capable of supporting a movable piston to actuate the hydraulic braking system. The cover is secured to the housing and the groove in the cover descends away from the center of the cover such that the groove is capable of directing fluid away from the center of the cover.

### DESCRIPTION OF THE DRAWINGS

In the accompanying drawings, which are incorporated in and constitute a part of this specification, embodiments of the invention are illustrated that, together with a general description of the invention given above and the detailed description given below, serve to illustrate the principles of this invention. The drawings and detailed description are not intended to and do not limit the scope of the invention or the claims in any way. Instead, the drawings and detailed description only describe embodiments of the invention, and other embodiments of the invention not described are encompassed by the claims.

FIG. 1 illustrates a perspective view of a master cylinder.

FIG. 2A illustrates a perspective view of a cover of a master cylinder.

FIG. 2B illustrates a cross-sectional view of the cover of FIG. 2A taken generally along the line A-A.

FIG. 3 illustrates an exploded view of a master cylinder.

FIG. 4 illustrates a second exploded view of a master cylinder.

FIG. 5 illustrates a perspective view of a housing of a master cylinder.

FIG. 6A illustrates a side view of a master cylinder having a decal.

FIG. 6B illustrates a cross-sectional view of the master cylinder of FIG. 6A taken generally along the line A-A.

FIG. 6C illustrates a magnified view of the interior of the reservoir of a master cylinder.

FIG. 7 illustrates a perspective view of a pressure cup for a master cylinder.

FIG. 8A illustrates a perspective view of a spring for a master cylinder.

FIG. 8B illustrates a top view of the spring of FIG. 8A for a master cylinder.

FIG. 9A is a perspective view of a cap for a master cylinder.

FIG. 9B illustrates a side view of the cap of FIG. 9A for a master cylinder.

FIG. 9C illustrates a cross-sectional view of the cap of FIG. 9B taken generally along the line A-A.

FIG. 10A illustrates a perspective view of a cap for a master cylinder.

FIG. 10B illustrates a side view of the cap of FIG. 10A for a master cylinder.

FIG. 10C illustrates a cross-sectional view of the cap of FIG. 10B taken generally along the line B-B.

### DETAILED DESCRIPTION

While the present invention is described with reference to the embodiments described herein, it should be clear that the present invention should not be limited to such embodiments. Therefore, the description of the embodiments herein is illustrative of the present invention and should not limit the scope of the invention as claimed. As described herein, a master cylinder is generally implemented into a surge actuator for use with a towing trailer; however, upon understand the detailed description and accompanying figures, it will be readily understood by one of ordinary skill in the art that embodiments of the described and illustrated master cylinder may be incorporated into a variety of other vehicles to facilitate braking of such vehicles.

Master cylinders may be designed to facilitate the braking of a trailer coupled to a towing vehicle. Typically, the braking systems of a towing vehicle are designed to slow and stop only the towing vehicle. It will readily be understood that as a towing vehicle slows or stops, it is advantage to provide apparatus, mechanisms or systems that also slow or stop a trailer being towed by the towing vehicle. Embodiments of the master cylinders described and disclosed herein may be designed to sense the slowing or stopping of a towing vehicle and apply a braking force to a trailer in proportion to the stopping or slowing of the towing vehicle.

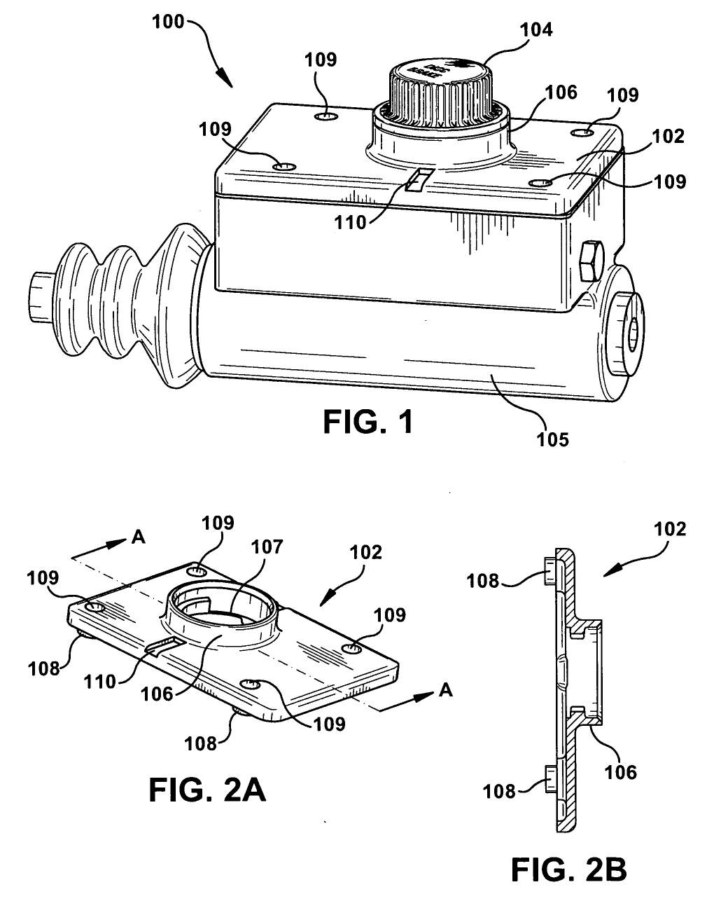

FIG. 1 illustrates an exemplary embodiment of a master cylinder 100. The master cylinder 100 may be arranged to utilize the force of a slowing or stopping towing vehicle to actuate the braking system to slow or stop the towed vehicle. As illustrated in FIG. 1, a master cylinder 100 may include a cover 102, a cap 104, and a housing 105. The master cylinder 100 may be constructed of metal, plastic or any other suitable material as will be appreciated by one of ordinary skill in the art. In an exemplary embodiment, the cover 102 and the housing 105 of the master cylinder 100 are manufactured or otherwise fabricated from a die cast metal, such as aluminum. Manufacturing such components from aluminum provides for durability and resistance to rust, oxidation, and other such corrosive effects. In another embodiment, the cover 102 of a master cylinder 100 may be manufactured or otherwise fabricated from a fiberglass or carbon fiber reinforced polymer, such as nylon or the like.

As can be seen in FIG. 1, a master cylinder 100 may be arranged as a self-contained unit. Such an arrangement allows for master cylinder 100 to be incorporated, integrated, or otherwise attached to the braking system of a trailer regardless of the design of the trailer.

FIGS. 2A and 2B illustrate a perspective and a cross-sectional view of the cover 102. The cover 102 includes a lip 106 that extends or rises above the upper surface of the cover 102 to define an access aperture or opening 107 passing through the cover 102. In one embodiment, the extended or raised lip 106 may be positioned in the center of the cover 102. As will be subsequently described, the extended lip 106 and cap 104 may be arranged such that the lip 106 may accept and reversibly secure the cap 104 to the cover 102 so as to close and seal the access opening 107. The opening 107 is arranged such that when the cap 104 is not secured to the lip 106, the opening 107 provides access to the housing 105 of the master cylinder 100. Such access allows for hydraulic fluid, or other such liquids, to be deposited into the housing 105 or removed from the housing 105 through the opening 107.

The cap 104 may be selectively removed from the extended lip 106 to facilitate the pouring of fluid into the housing 105 and the removal of fluid from the housing 105 through the opening 107. When an appropriate operational volume of fluid is deposited in the housing 105 or an appropriate volume of fluid is removed from the housing 105, the cap 104 may be secured in the lip 106 to reseal the opening 107 and prevent fluid from leaking through the opening 107. The cap 104, extended lip 106, and opening 107 may be generally circular in cross-sectional shape, or may be any shape that allows for reversible sealing of the opening 107.

The lip 106 may be arranged to facilitate the pouring of fluid into the housing 105 and to prevent contaminants from entering the housing 105. For example, the lip 106 may serve as a raised filler lip onto which an operator may rest a fluid container used to pour fluid into the housing 105. By using the lip 106 to rest a fluid container, an operator may more readily fill the housing 105 with fluid without concerns of spilling fluid onto the cover 102 or other exterior surfaces of the master cylinder 100. In addition, the lip 106 may provider a barrier to prevent debris, dirt, or other such contaminants residing on the surface of the cover 102 from passing through the opening 107 and entering the master cylinder 100. For example, when the cap 104 is removed from the extended lip 106 to allow fluid to be added, there is the possibility that contaminants residing on the surface of the cover 102 may flow into or otherwise enter the housing 105. However, the lip 106 extends above the surface of the cover 102 to block the flow of such contaminants through the opening 107 and into the housing 105.

The cover 102 may also include a groove or channel 110 along the upper surface of the cover 102. The groove 110 is arranged as a drainage groove to drain or otherwise move fluids and other substances away from the cover 102. As will be readily understood, a master cylinder 100 that is coupled to a trailer is commonly exposed to the elements during normal operation. For example, the master cylinder 100 is commonly exposed to dirt, grease, moisture, and other such contaminants as a trailer is towed behind a towing vehicle. Such contaminants may settle on the surface of the cover 102 and may cause damage to the cover 102, in the form of rust, oxidation, or other such corrosion, or may cause damage to internal components of the master cylinder 100 if allowed to enter the housing 105.

The drainage grooves 110 are arranged to prevent water and other such fluids that promote corrosion from settling on the cover 102. The grooves 110 are angled, slanted, descended, or otherwise arranged to promote the flow of fluid and contaminants away from the opening 107 and to generally encourage fluids and contaminants to flow off the cover 102. Such an arrangement is particularly affective in controlling moisture and contaminants when the cap 104 is removed from the extended lip 106 during regular maintenance, such as during the filling of the master cylinder 100 with fluid or the bleeding of pressure from the braking system.

In one embodiment, the exterior surface of the cover 102 may be generally angled downward and away from the extended lip 106 to assist the grooves 110 in promoting the flow of fluids and other contaminants way from the opening 107. Although the cover 102 as described and illustrated herein includes one drainage groove 110, other embodiments may include a plurality of grooves or a system of grooves that include multiple legs or channels to promote the flow of fluid and other contaminants away from the opening 107 and off of the cover 102.

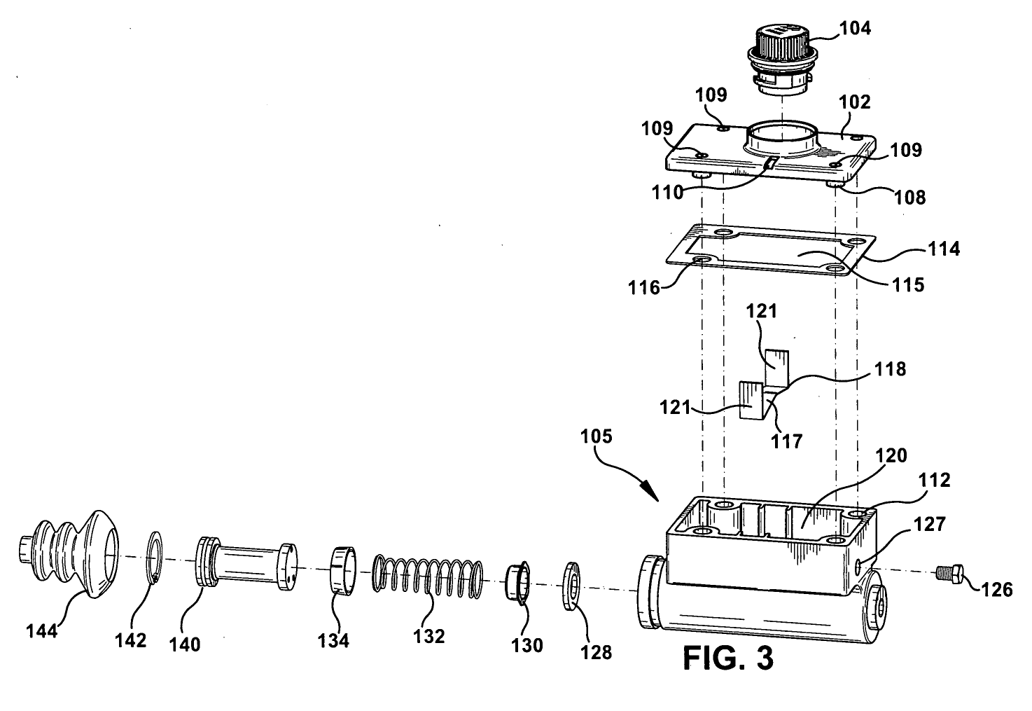

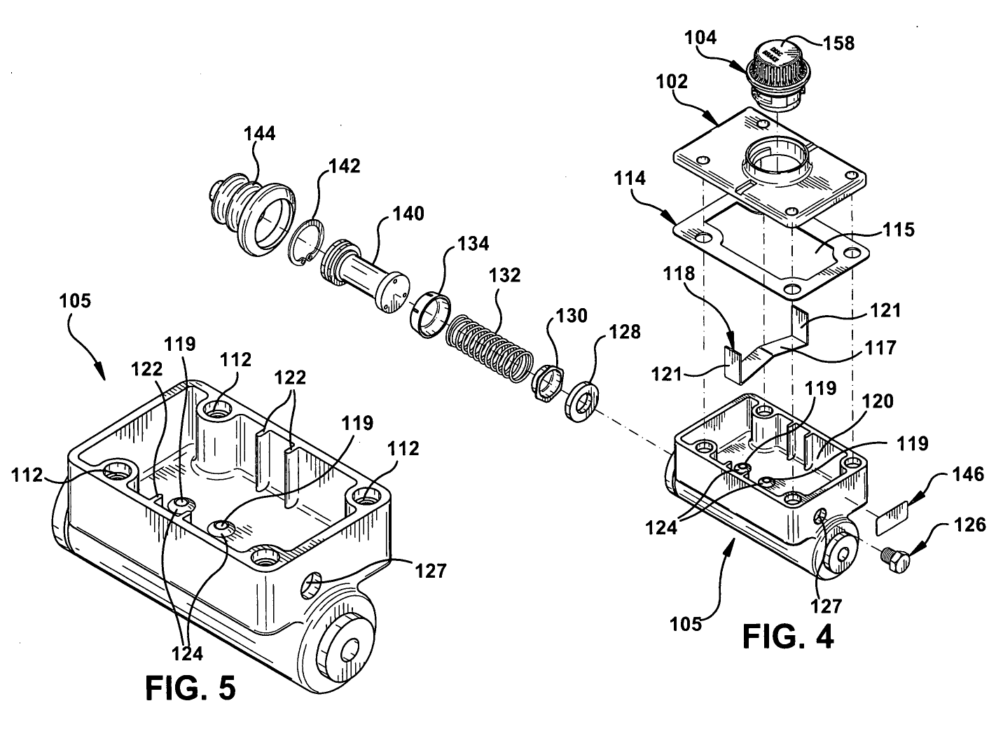

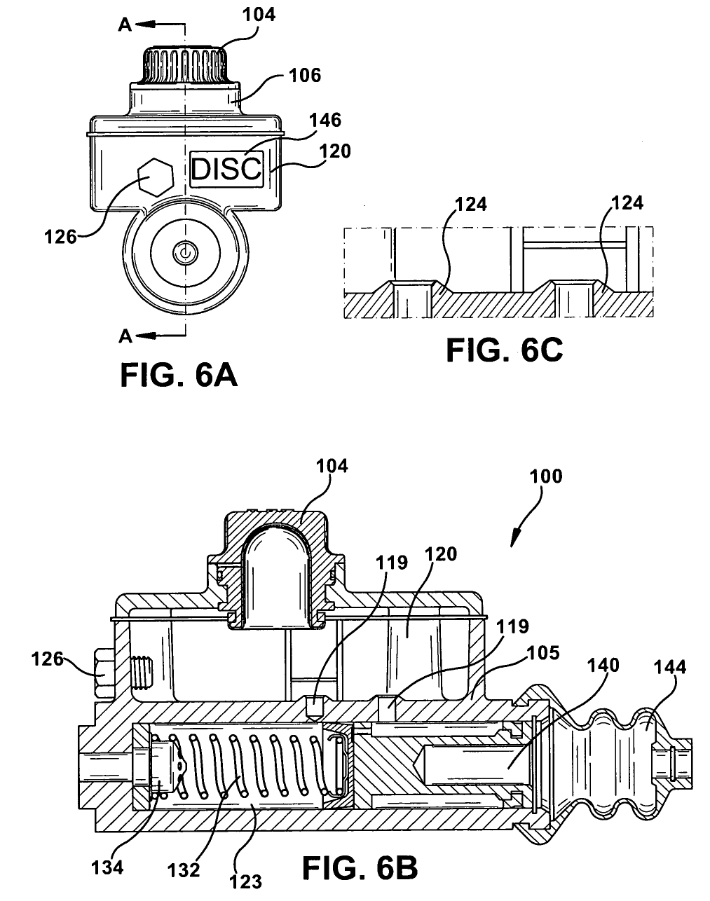

FIGS. 3 and 4 illustrate an exploded view of an exemplary embodiment of a master cylinder 100. The housing 105 includes a fluid reservoir 120 with an opening at the top of the housing 105. The housing 105 also includes a bore or chamber 123 formed through the housing 105. The bore 123 is generally positioned below the reservoir 120 (as best seen in FIG. 6B) and a pair of bleed valves 119 provides a fluid path between the reservoir 120 and the bore 123. The master cylinder 100 further includes a gasket 114 for sealing the interface between the cover 102 and housing 105 and a splashguard 118 positioned within the reservoir 120.

FIGS. 3 and 4 also illustrate a number of components that may be positioned within the bore 123. For example, a bumper 128, a check valve 130, a compression spring 132, a pressure cup 134, a piston 140, and a snap ring 142 may all be positioned within the bore 123 to facilitate the actuation of the trailer braking system. Specifically, the piston 140 is generally arranged to move back and forth along the axis of the bore 123 to actuate and disengages the trailer braking system.

In addition, a dust boot 144 may be attached to an opening of the bore 123. The dust boot 144 may prevent foreign particles, such as dirt, dust, grease, moisture, and the like from entering the bore 123 or fluid reservoir 120. The piston 140 may compress the spring 132 to drive fluid through the pressure cup 134 and actuate the braking system of the trailer. The spring 132 may return the piston back to a “neutral” position in which fluid may again enter the bore 123. The master cylinder 100 may be arranged such that the pressure within the master cylinder 100 selectively actuates and disengages the braking system of a trailer or other such towed vehicle.

In an embodiment of a master cylinder 100, the gasket 114 is seated or otherwise positioned between the cover 102 and the housing 105 prior to the assembly of the master cylinder 100. The gasket 114 serves as a sealing member to seal the reservoir 120 formed by the assembly of the cover 102 to the housing 105. The gasket 114 is arranged to prevent fluid within the reservoir 120 of the housing 105 from flowing through the interface between the cover 102 and the housing 105.

The cover 102 may be secured to the housing 105 through fasteners, such as screws, bolts, rivets, and the like (not shown). The cover 102 includes a plurality of fastener apertures 109 and the housing 105 includes a plurality of matching fastener apertures 112. The fastener apertures 109 in the cover 102 are arranged to align with the fastener apertures 112 of the housing 105 such that when the cover 102 is fitted onto the housing 105, fasteners may be passed through the aligned fastener apertures 109, 112 and be secured in the fastener apertures 112 of the housing 105. Such an arrangement may secure the cover 102 to the housing 105. The cover 102 may be attached to the housing 105 such that the attachment is reversible, or alternatively, the cover 103 may be attached to the housing 105 such that the attachment is not reversible. In one embodiment, the fastener apertures 112 of the housing 105 may be threaded such that threaded screws or bolts passing through the fastener apertures 109 of the cover 102 may be secured into the fastener apertures 112 of the housing 105 to secure the cover 102 to the housing 105.

The gasket 114 may include a plurality of apertures 116 that match and align with the fastener apertures 109, 112 of the cover 104 and housing 105. In such an arrangement, the gasket 114 may be positioned between the cover 102 and the housing 105 to seal the interface without interfering with fasteners passed through the fastener apertures 109, 112 to secure the cover 102 to the housing 105. The gasket 114 further includes an opening 115 coinciding with the access opening 107 in the cover 102. The gasket opening 115 is arranged so as not to interfere with fluids passing through the access opening 107, i.e., the gasket opening 115 does not interfere with the fluid communication between the access opening 107 and the fluid reservoir 120 located in the housing 105.

The cover 102 may also include a plurality of posts 108 extending downward from the fastener apertures 109. The posts 108 may be arranged for mating engagement and alignment with the gasket apertures 116 and fastener apertures 112 of the housing 105. Such an arrangement may maintain the alignment or orientation of the gasket 114 with respect to the cover 102 and housing 105 during and after assembly of the master cylinder 100. Engagement of the posts 108 with the fastener apertures 112 of the housing also maintains the alignment or orientation of the cover 102 with respect to the housing 105 during and after assembly of the master cylinder 100. Maintaining alignment and orientation of components reduces or eliminates issues of wear, leakage, or misalignment of the gasket 114, cover 102, housing 105, and other such components of the master cylinder 100.

A coating or sealant may be applied to the gasket 114 prior to assembly of the master cylinder 100 to enhance the sealing capabilities of the gasket 114. In one embodiment, an adhesive is applied to both sides of the gasket 114 to adhere or otherwise bond the gasket 114 to both the cover 102 and the housing 105 during and after assembly of the master cylinder 100. Such an arrangement may enhance the seal provided by the gasket 114, along with enhancing the durability and service life of the seal provided by the gasket 114. Adhesives used in the assembly of the master cylinder 100 may be arranged to cure through the application of pressure. The tightening of fasteners coupling the cover 102 to the housing 105 may generate the appropriate pressure needed to cure adhesives.

In another embodiment, the adhesive may be arranged to provide a bond that allows for disassembly of the master cylinder 100 without damaging the gasket 114, cover 102, or housing 105. In one example, the adhesive may be selected such that the bond created by the adhesive is loosened or broken by the application of a chemical that does not affect the gasket 114 or other master cylinder components. In another example, the adhesive may be selected such that the bond created by the adhesive is sufficient to enhance the sealing ability of the gasket 114, yet may still allow for separation of the gasket 114 from the cover 102 and housing 105 through the application of non-destructive mechanical force.

In another embodiment, a gap filler may be applied to both sides of the gasket 114. A gap filler may enhance the seal of the gasket 114 by filling gaps between the gasket 114 and the cover 102 and housing 105; however, the gap filler may not include any adhesive properties. In such an arrangement, the seal is enhanced without substantially affecting the disassembly of the master cylinder 100. Although the embodiments described include adding a coating to both sides of the gasket 114, it will be readily understood that a coating may be applied to only one side of a gasket 114 or may be applied directly to the cover 102 or housing 105 to enhance the seal between the cover 102 and housing 105. It will also be appreciated that the application of adhesives further forms a master cylinder 100 that is a fully self-contained and separate unit that may be assembled with or other wise utilized by a wide variety of trailers.

With further reference to FIGS. 3 and 4, the master cylinder 100 includes a splashguard 118. The splashguard 118 is positioned within the reservoir 120 and generally located below the access opening 107 in the cover 102. The splashguard may be utilized as a fluid deflection member to facilitate operation or maintenance of the master cylinder 100. In one embodiment of the master cylinder 100, pressure in brake lines attached to the master cylinder 100 may be relieved to optimize the performance of the braking system. The pressure may be commonly relieved through bleed valves 119 located in the bottom of the reservoir 120. The splashguard 118 is generally positioned such that the splashguard 118 blocks the path between the bleed valves 119 and the access opening 107 in the cover 102.

The reservoir 120 generally contains brake fluid, or other similar hydraulic fluids. When pressure is bled from the brake lines into the reservoir 120, the fluid in the reservoir 120 may be disturbed. Such disruption often causes fluid to flow upward towards the access opening 107. The splashguard 118 is positioned and arranged to deflect such upwardly flowing fluid to minimize or prevent the fluid from flowing to and through the access opening 107 during bleeding of the brake lines.

As illustrated in FIG. 5, in an embodiment of a master cylinder the housing 105 may have baffles 122 along the sides of the reservoir 120 for retaining and aligning the splashguard 118. In the exemplary embodiment illustrated in FIGS. 3 and 4, the splashguard 118 includes a pair of tabs 121 that extend upward from a fluid deflection body portion 117 of the splashguard 118. The tabs 121 are sized to slide into and be secured by the baffles 122. The tabs 121 are also sized such that when the tabs 121 are positioned in the baffles 122 and the master cylinder 100 is assembled, the cover 102 contacts the top portions of the tabs 121 to further secure or maintain the positioning of the tabs 121 in the baffles 122.

The tabs 121 and body 117 of the splashguard 118 are arranged such that when the tabs 121 are secured in the baffles 122, the body 117 is appropriately positioned to deflect fluid disturbed by bleeding the brake lines from splashing through the access opening 107. Although an embodiment of the splashguard 118 is described and illustrated herein as having a body 117 and a pair of tabs 121, it will be readily appreciated by one of ordinary skill in the art that a splashguard 118 may be of any other appropriate shape or position that blocks the fluid paths from the bleed valves 119 to the access opening 107. The splashguard 118 is preferably made out of stainless steel to resist rust or other such corrosion, but may also be manufactured or otherwise fabricated from any other material suitable for contact with hydraulic fluid and capable of deflecting disturbed fluid.

In addition to deflecting fluid during bleeding of brake lines, the splashguard 118 may deflect fluid disturbed by movement of the piston 140 within the master cylinder to prevent such fluid from flowing out of the access opening 107. It will also be understood that the splashguard 118 may be arranged to be retained within the reservoir 120 without use of the baffles 122. In one example, the splashguard 118 may be shaped or bent in such a manner so as to be self-retained within the reservoir 120.

FIGS. 3 and 4 illustrates a reservoir fitting 126 that is connected to the reservoir 120 through an aperture 127 in the side of the reservoir 120. The reservoir fitting 126 may be removably secured to the aperture 127 of the reservoir 120 to facilitate reverse lockout solenoid retrofitting.

The cap 104 and the extending lip 106 may each include mating threads such that the cap 104 may be reversibly secured to the lip 106 by engaging the mating threads and twisting or otherwise turning the cap 104 with respect to the lip 106. In one embodiment, the threads of the cap 104 are located on an outside surface of the cap and the threads of the lip 106 are located on an inside surface of the lip 106. In such an arrangement, the cap 104 is positioned and secured within the lip 106 to seal the access opening 107 against leakage of fluid from the reservoir 120. In another embodiment, the threads of the cap 104 are located on an inside surface of the cap 104 and the threads of the lip 106 are located on an outside surface of the lip 106. In such an arrangement, the lip 106 is positioned and secured within the cap 104 to seal the access opening 107 against leakage of fluid from the reservoir 120.

It will be readily appreciated that embodiments as described herein provide for the cap 104 to be reversibly secured to the cover 102. Such arrangements allow for the cap 104 to be removed from the cover 102 for system functions such as filling the reservoir 120 with a fluid, venting the reservoir 120, bleeding the braking system, and the like. The cap 104 may include features on the exterior surfaces of the cap 104 to facilitate manually gripping the cap 104. The cap 104 may further include a diaphragm 154 and a radial seal to further facilitate the sealing of the access opening 107 with the cap 104.

In an embodiment, the threads on the cap 104 and the threads of the lip 106 may both be relatively coarse threads. In such an arrangement, rotating or twisting the cap 104 into the extended lip 106 results in a relatively large vertical displacement with respect to the amount the cap 104 is turned. Such relatively large vertical displacements may provide a more user-friendly arrangement than a cap with fine threads. In addition, course threads are generally more durable and more resistant to stripping or other such deformations due to repeated use as compared to fine threads. In an embodiment, the threads are arranged such that a quarter-turn, i.e., rotating the cap 104 through ninety degrees of rotation, moves the cap 104 from a fully engaged and sealed position to an disengaged position where the cap 104 may be removed from the cover 102.

In an embodiment, a master cylinder 100 may include a decal 146 attached to an exterior surface of the master cylinder 100. In one example, as seen in FIGS. 4 and 6A, a decal 146 is adhered or otherwise attached to the outside of the housing 105. In addition, such a decal 146 may be adhered to the cover 102, cap 104, or elsewhere on the master cylinder 100. The decal 146 may include information to facilitate the use and operation of the master cylinder 100. For example, the decal 146 may include information relating to the manufacture of the master cylinder 100; information relating to the type of brake assembly connected to the master cylinder 100, for example “disc” or “drum” brakes; information relating to inspection or repair of the master cylinder 100; and the like. The decal 146 may also be used to customize the master cylinder 100 with company, brand, or product logos and information. FIG. 6A illustrates an embodiment of the decal 146 displaying the type of braking assembly connected to the master cylinder 100, i.e., “disc” brakes. The indicia representing the information may be printed, imaged, inked, engraved, or otherwise affixed onto the decal 146.

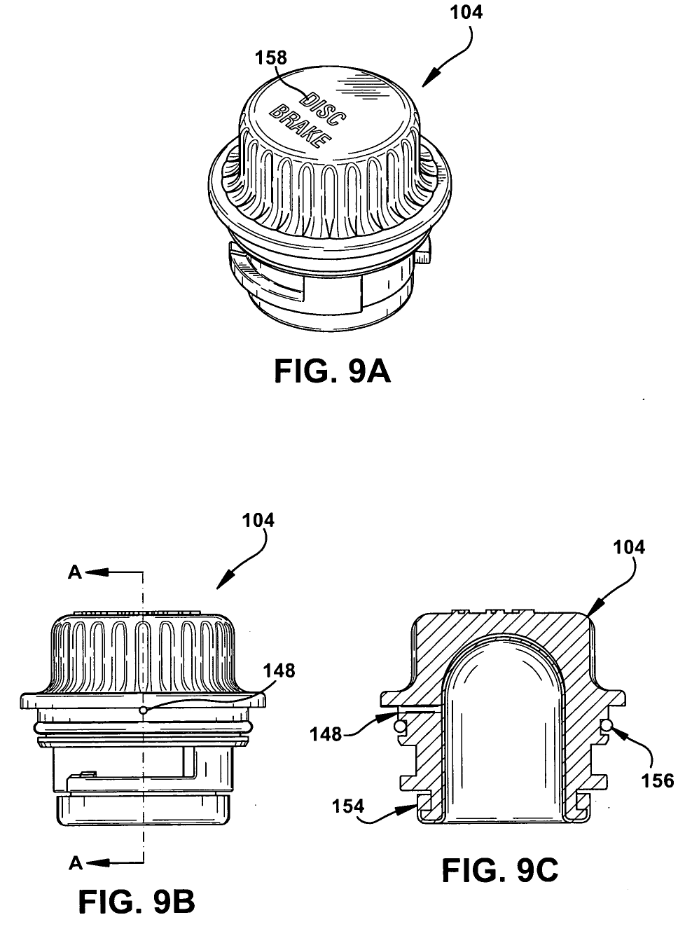

In another embodiment, information may be molded, embossed or otherwise incorporated into components of the master cylinder 100. In one example, as illustrated in FIG. 9A, the cap 104 may be molded such that markings 158 are incorporated into the cap 104. Such markings 158 may represent information that aids in managing inventory and facilitating the identification of master cylinders and actuators. Similar to the decal 146 described above, the markings 158 may include information relating to the manufacture of the master cylinder 100; information relating to the type of brake assembly connected to the master cylinder 100, for example “disc” or “drum” brakes; information relating to inspection or repair of the master cylinder 100; and the like. The markings 158 may also be used to customize the master cylinder 100 with company, brand, or product logos and information.

FIG. 6B illustrates a cross-sectional view of the master cylinder 100 taken generally along line A-A of FIG. 6A. FIG. 6B illustrates the interaction of the piston 140, the spring 132 and the pressure cup 134. In an embodiment, the piston 140 is moved to compress the spring 132, which forces fluid out of the pressure cup 134, to engage the brakes of a trailer. The spring 132 may force the piston 140 away from the pressure cup 134 to disengage the brakes.

Also as illustrated in FIG. 6B and the magnified view of FIG. 6C, the reservoir 120 may have raised bosses 124 around the bleed valves 119 located along the bottom of the reservoir 120. In such an embodiment, the bosses 124 may be arranged to limit or prevent dirt, debris, and such contaminants from entering the braking system. For example, the bosses 124 may block contaminants that are floating in fluid in the reservoir 120 from entering the braking system, where such contaminants may cause damage to the system.

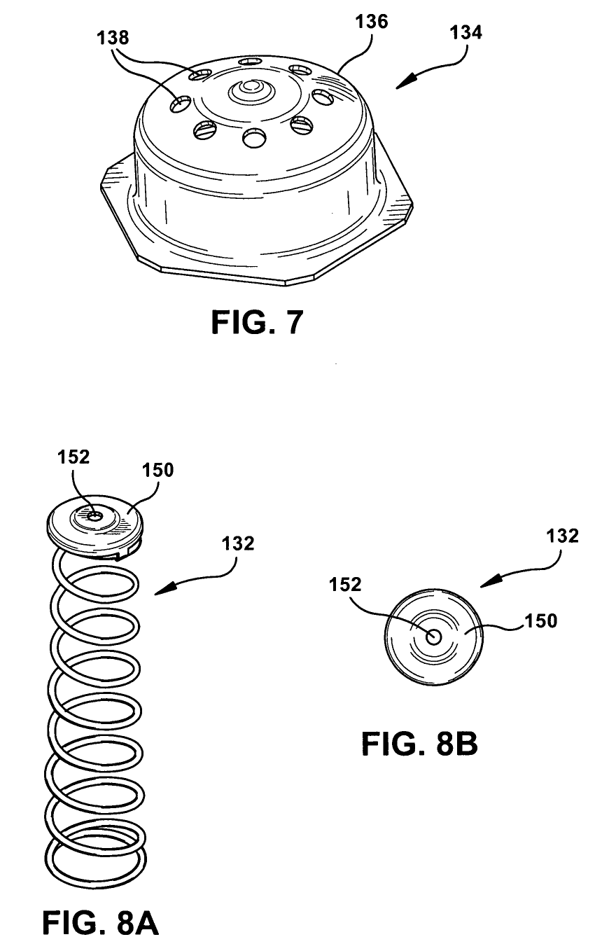

An exemplary embodiment of the pressure cup 134 is illustrated in FIG. 7. The pressure cup 134 may include a plurality of apertures 138 passing through a top portion 136 of the pressure cup 134. Such apertures 138 may be arranged in a symmetrical manner about a center of the pressure cup 134. Alternatively, the apertures 138 may be arranged in any other that allows for fluid communication between the master cylinder 100 and the braking system.

An exemplary embodiment of the spring 132 is illustrated in FIGS. 8A and 8B. The spring 132 may have a top surface 150 having an aperture 152 therethrough. The aperture 152 may allow for fluid communication between the reservoir 120 and the pressure cup 134. The fluid may pass through the aperture 152 of the spring 132 and into the pressure cup 134 to actuate the brake assembly.

An exemplary embodiment of the cap 104 is illustrated in FIGS. 9A, 9B and 9C. Similar to previous descriptions, the cap 104 may be a quarter twist cap that facilitates a user quickly and easily removing of the cap 104 from the cover 102 and the user quickly and easily returning the cap 104 to the cover 102 to reseal the master cylinder 100. A quarter twist cap 104 that includes course threads eases assembly by eliminating awkward fine threads that often cross thread or mismatch. The cap 104 may also include a radial seal and pressure-normalizing diaphragm 154 that further reduces or eliminates leaks at the caps 104. The diaphragm 154 may be manufactured or otherwise fabricated from rubber or any other material capable of reducing or eliminating leaks. As best seen in FIGS. 9B and 9C, the cap 104 also includes a vent hole 148. The vent hole 148 allows the reservoir 120 and cap 104 to vent to the atmosphere. The cap 104 also includes an o-ring 156 to assist in securing and sealing the cap 104 to the cover 102.

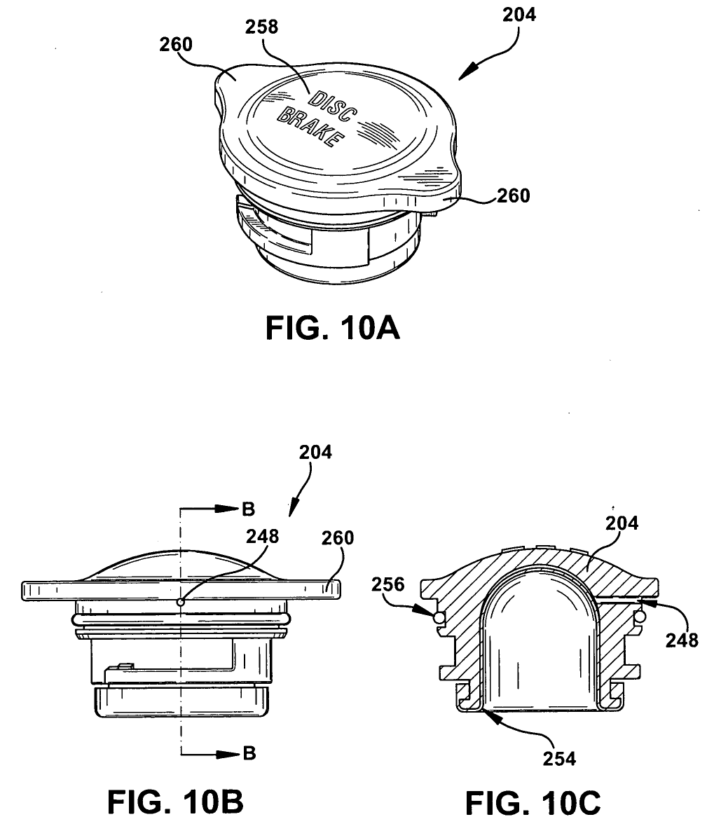

Another exemplary embodiment of a cap 204 is illustrated FIGS. 10A, 10B and 10C. The cap 204 includes a low profile. The low profile may facilitate attaching the master cylinder 100 to a variety of trailers. The low profile may limit the interference between the master cylinder 100 and trailers as the master cylinder 100 is attached or secured to trailers. The cap 204 includes a radial seal and pressure-normalizing diaphragm 254 that further reduces or eliminates leaks at the caps 204. The diaphragm 254 may be manufactured or otherwise fabricated from rubber or any other material capable of reducing or eliminating leaks. As best seen in FIGS. 10B and 10C, the cap 204 also includes a vent hole 248. The vent hole 248 allows the reservoir 120 and cap 204 to vent to the atmosphere. The cap 204 also includes an o-ring 256 to assist in securing and sealing the cap 204 to the cover 102. The cap 204 includes a par of protrusions 260 to assist a user in twisting the cap 204 onto and off the cover 102.

With further reference to FIG. 10A, the cap 204 may also include embosses, markings, or the like 258 to help aid in inventory and make identification of the master cylinder 100 and actuator quick and easy. Such markings 258 may include information relating to the manufacture of the master cylinder 100; information relating to the type of brake assembly connected to the master cylinder 100, for example “disc” or “drum” brakes; information relating to inspection or repair of the master cylinder 100; or the like. The markings 258 may also be used to customize the master cylinder 100 with company or product logos and information.

The invention has been described above and, obviously, modifications and alternations will occur to others upon a reading and understanding of this specification. The claims as follows are intended to include all modifications and alterations insofar as they come within the scope of the claims or the equivalent thereof.

Having thus described the invention, I claim:

1. A master cylinder in communication with a hydraulic brake system, the master cylinder comprising:
a housing having a fluid reservoir formed therein;
a bore extending through the housing, the bore capable of supporting a movable piston for actuation of the hydraulic brake system;
a cover secured to the housing; and
a groove formed in the cover, the groove descending away from a center of the cover, wherein the groove is capable of directing fluid away from the center of the cover.

2. The master cylinder of claim 1 wherein the cover has an aperture with a raised lip that provides fluid communication to the fluid reservoir.

3. The master cylinder of claim 2 further comprising:
a cap removably securable to the raised lip of the cover to prevent fluid communication between the fluid reservoir and the aperture.

4. The master cylinder of claim 3 wherein the cap has coarse threads.

5. The master cylinder of claim 4 wherein the cap is rotatable from a fully engaged and sealed position to a disengaged position by less than one rotation of the cap.

6. The master cylinder of claim 1 further comprising:
a gasket sealing a top of the fluid reservoir along an interface between the housing and the cover.

7. The master cylinder of claim 6 further comprising:
sealant positioned between the gasket and the housing and the gasket and the cover.

8. The master cylinder of claim 6 further comprising:
posts securing the cover and the gasket to the housing, the posts extending from the cover through the gasket to maintain alignment of the gasket with respect to the cover and the housing.

9. A master cylinder in communication with a hydraulic brake system, the master cylinder comprising:
a fluid reservoir defined by a bottom surface and walls extending from the bottom surface;
a cover securable to the fluid reservoir, the cover having an aperture formed therein, the aperture in fluid communication with the fluid reservoir; and
a fluid deflection member positioned between the aperture and the bottom surface of the fluid reservoir, the fluid deflection member having a planar surface limiting direct fluid communication between the aperture and the bottom surface of the fluid reservoir.

10. The master cylinder of claim 9 wherein the bottom surface has bosses extending from the bottom surface toward the cover.

11. The master cylinder of claim 9 further comprising:
a baffle formed along the walls of the fluid reservoir, the baffle sized and shaped to secure the fluid deflection member in the fluid reservoir.

12. The master cylinder of claim 9 further comprising:
a housing having the fluid reservoir formed therein, the housing having a bore formed therein, the bore capable of supporting a movable piston for actuation of the hydraulic brake system.

13. The master cylinder of claim 12 further comprising:
a gasket positioned between the housing and the cover, the gasket sealing the cover to the housing.

14. The master cylinder of claim 13 further comprising:
means for fastening the cover and the gasket to the housing.

15. A master cylinder connectable to a brake actuator and in communication with a hydraulic brake system of a towed vehicle, the master cylinder comprising:
a housing having a bore and a fluid reservoir formed therein, the bore capable of supporting a movable piston for actuation of the hydraulic brake system;
a cover securable to the fluid reservoir;
an aperture formed in the cover and extending into the fluid reservoir;
a plurality of grooves extending away from the aperture and descending toward an outer edge of the cover; and
a cap removably securable to the aperture to prevent fluid communication between the fluid reservoir and the aperture.

16. The master cylinder of claim 15 wherein the housing is die cast.

17. The master cylinder of claim 16 wherein the housing is die cast of powdered metal.

18. The master cylinder of claim 15 wherein the aperture has a lip extending outward from a top surface of the cover.

19. The master cylinder of claim 15 wherein the cap has a diaphragm and a seal to prevent fluid communication from the fluid reservoir to the aperture.

20. The master cylinder of claim 15 wherein the cap is rotatable from a fully engaged and sealed position to a disengaged position by less than one rotation of the cap.
